(19) United States
(12) Patent Application Publication
(10) Pub. No.: US 2009/0268894 A1
(43) Pub. Date: Oct. 29, 2009

(54) Communication Device

(75) Inventor: Shunsuke MINAMIKAWA, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi, (JP)

(21) Appl. No.: 12/406,288

(22) Filed: Mar. 18, 2009

(30) Foreign Application Priority Data
Apr. 24, 2008 (JP) 2008-113852

(51) Int. Cl. H04M 3/42

(52) U.S. Cl. 379/207.02

(57) ABSTRACT

A communication device is provided. The communication device includes a call origination unit that originates a call to a communication terminal device; a shift unit that sets as a granted device the communication terminal device to which the call has been originated, and that shifts the communication device to a limit mode in which communication with a communication terminal device which is not set as a granted device is limited, after the call is originated by the call origination unit; and a control unit that determines whether an incoming call is from a granted device when an incoming call is received while the communication device is in the limit mode, that permits communication if the incoming call is from a granted device, and that limits communication if the incoming call is from a device other than a granted device.

### CROSS-REFERENCE TO RELATED APPLICATIONS

This application claims priority from Japanese Patent Application No. 2008-113852 filed on Apr. 24, 2008, the entire contents of which are incorporated herein by reference.

### TECHNICAL FIELD

Devices consistent with the present invention relate to communication devices and, more particularly, to communication devices which have a line use limit function.

### BRIEF DESCRIPTION OF RELATED ART

As far as communication devices are concerned, there are cases in which an incoming call from a specific party is desired to be received. For instance, some related art facsimile (FAX) machines have a refusal mode for refusing printing and saving of FAX data. The FAX machine operates in the refusal mode during an absence of a recipient, whereby the safety of information is assured. However, there are occasions in which, after returning from the absence, the recipient would like to acquire the refused FAX data. In this case, the recipient asks a sender of the FAX data to retransmit the FAX data, to thus wait for retransmission of the FAX data. However, if the FAX machine is occupied by another communication when the sender attempts to resend the FAX data, the recipient cannot receive the FAX data. In such a case, by granting only a specific party (the sender who is asked to retransmit the FAX data in the above case) permission for communication, the FAX data can be received without fail. Moreover, even when transmission of important FAX data is previously expected, permission of communication with only a specific party is effective for reliably receiving the FAX data.

JP-A-02-82860 describes a related art FAX machine in which, when the FAX machine belongs to a predetermined time zone, the FAX machine grants only the party of a specific phone number permission for transmission or receipt.

However, the related-art communication device has some disadvantages. For example, the related art FAX machine, such as described in JP-A-02-82860, requires a user to register a party and a time zone that are to be granted permission for communication. Therefore, the operation imposes inconvenience on the user. Moreover, in a case in which there are many parties, a number of registration operations equal to the number of switchable parties are required. Accordingly, as the number of registration operations increases, the burden is increased on the user and registration operations become very complicated.

### SUMMARY

Illustrative aspects of the present invention provide a communication device capable of setting parties to be granted permission for communication, without involvement of complicated operations.

According to an illustrative aspect of the present invention, there is provided a communication device comprising a call origination unit that originates a call to a communication terminal device; a shift unit that sets as a granted device the communication terminal device to which the call has been originated, and that shifts the communication device to a limit mode in which communication with a communication terminal device which is not set as a granted device is limited, after the call is originated by the call origination unit; and a control unit that determines whether an incoming call is from a granted device when an incoming call is received while the communication device is in the limit mode, that permits communication if the incoming call is from a granted device, and that limits communication if the incoming call is from a device other than a granted device.

### BRIEF DESCRIPTION OF THE DRAWINGS

FIG. 1 is a block diagram showing a general configuration of a FAX machine according to a first exemplary embodiment of the present invention;

FIG. 2 is a view showing an example of a registration file recording an address of a granted device;

FIG. 3 is a flowchart showing procedures of retransmission request processing of the FAX machine of FIG. 1;

FIG. 4 is a flowchart showing procedures of incoming call processing of the FAX machine of FIG. 1;

FIG. 5 is a flowchart showing procedures of call origination processing of the FAX machine of FIG. 1;

FIG. 6 is a flowchart showing procedures of automatic cancellation processing of the FAX machine of FIG. 1;

FIG. 7 is a block diagram showing a general configuration of a FAX machine according to a second exemplary embodiment of the present invention;

FIG. 8 is a view showing an example of a database (a refusal history) recording information about the history of refusal of incoming calls;

FIG. 9 is a flowchart showing procedures of retransmission request processing of the FAX machine of FIG. 7;

FIG. 10 is a view showing an example of a database (a requested party list) recording address information about retransmission requested parties;

FIG. 11 is a flowchart showing procedures of incoming call processing of the FAX machine of FIG. 7; and

FIG. 12 is a flowchart showing procedures of call origination processing of a FAX machine according to a third exemplary embodiment of the present invention.

### DESCRIPTION OF EXEMPLARY EMBODIMENTS

Exemplary embodiments of the present invention will be described hereunder in detail by reference to the accompanying drawings. The present exemplary embodiment is directed to application of the present inventive concept to a FAX machine.

[Overall Configuration of a FAX Machine]

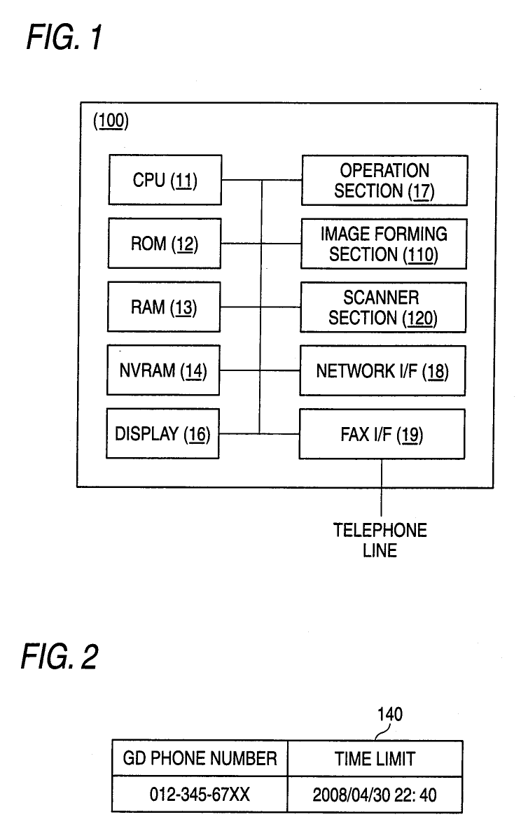

As shown in FIG. 1, a FAX machine 100 according to a first exemplary embodiment has a central processing unit (CPU) 11 (an example of call origination unit, shift unit, control unit, cancellation unit, informing unit, and selection unit), a read only memory (ROM) 12, a random access memory (RAM) 13, nonvolatile memory (hereinafter abbreviated as “NVRAM”) 14 (an example of storage unit), a display section 16, an operation section 17, an image forming section 110, a scanner section 120, a network interface 18, and a FAX interface 19.

The CPU 11 performs arithmetic operation for implementing various functions, such as a scan function, a print function, and a FAX communicator function of the FAX machine 100, and serves as the center of control. The ROM 12 stores various control programs, settings, initial values, and the like, for controlling the FAX machine 100. The RAM 13 is utilized as a work area into which various control programs are read or a storage area for temporarily storing image data, and the like. The NVRAM 14 is storage means (Nonvolatile RAM) exhibiting a nonvolatile nature and stores various settings, image data, and others.

The network interface 18 is coupled to an information device (not shown), such as a personal computer (PC), and can establish mutual data communication with the information device by way of the network interface 18. The FAX interface 19 is for establishing FAX communication and is coupled to a telephone line. Specifically, the FAX interface 19 is made up of a network control unit (NCU), a modem, and the like.

The FAX machine 100 performs processing for producing on a sheet an image, which is based on the FAX data received by the FAX interface 19 by means of the image forming section 110. The FAX machine 100 also performs processing for preparing FAX data from image data read by the scanner section 120 and image data input by way of the network interface 18 and transmitting the FAX data to a called party by way of the FAX interface 19.

The FAX machine 100 has an “ordinary mode” for performing ordinary phone communication processing and FAX receipt processing and an “absence mode” for limiting FAX receipt and phone answering processing. Switching between the respective modes can be performed by user operation, or by computer operation.

The FAX machine 100 also has a “limit mode” for limiting communication with a party having a phone number other than a specified set of phone numbers. The FAX machine 100 has a registration file 140 for registering a phone number of a communication terminal device for which communication is granted (hereinafter called a “granted device”), and determines whether or not to grant communication by reference to the registration file 140 when in the limit mode. Specifically, as shown in FIG. 2, a phone number of a granted device and a time limit that is a period of time during which the limit mode is forcefully canceled are recorded in the registration file 140.

[Operation of the FAX Machine]

### First Exemplary Embodiment

Operation of the FAX machine 100 will be subsequently described. An effective period for the limit mode is previously set in the FAX machine 100. In the first exemplary embodiment, the effective period is set to 60 minutes.

[Retransmission Request Processing]

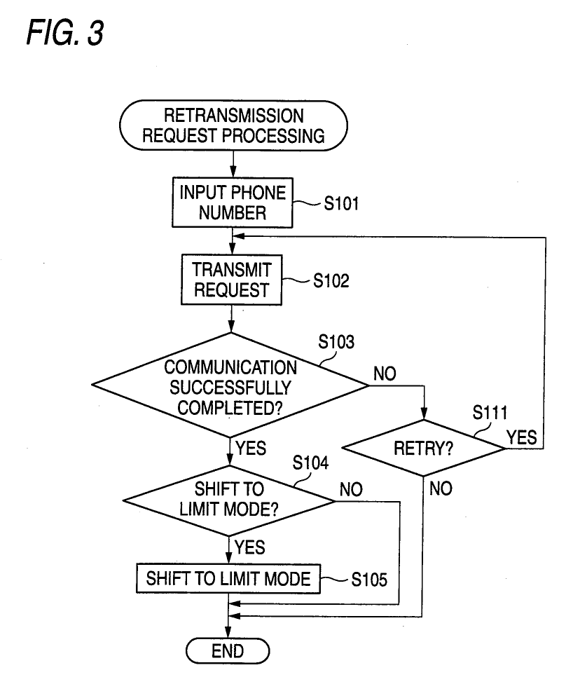

First, retransmission request processing of the FAX machine 100 is described by reference to a flowchart shown in FIG. 3. In the FAX machine 100, a voice message for requesting retransmission by phone or a request letter for issuing a retransmission request by FAX is previously stored in the ROM 12, and a retransmission request is issued by either of the methods. The FAX machine 100 performs switching to the limit mode by retransmission request processing. Retransmission request processing is performed by means of the user operating the operation section 17 or alternatively by instruction from a computer.

First, a phone number of a party which is to be sent a request for retransmission of FAX data, and the like, (hereinafter often called a “retransmission requested party”) is input (S101). Entry of a phone number may also be performed by directly inputting a phone number or indirectly inputting a phone number by using an address book. Subsequently, a call is originated to a communication terminal device of a requested party, thereby transmitting a request for retransmission (S102). The transmission of the request for retransmission is an example of a call origination unit. The request for retransmission may also be made by phone or FAX.

In S103, a determination is first made as to whether or not communication of the retransmission request has been successfully completed (S103). When an anomaly is found in a communication terminal device of a called party or when a limitation is imposed on communication, a communication error arises, and the retransmission requests ends in a failure. Accordingly, if it is determined that communication has not been completed (NO in S103), an inquiry as to whether or not to perform retry of the retransmission request is sent (S111) If it is determined that retry is requested (YES in S111), processing returns to S102, where the retransmission request is again transmitted. On the other hand, if it is determined that retry is not requested (NO in S111), processing ends.

In S103, if it is determined that communication is successfully completed (YES in S103), an inquiry as to whether or not to effect a shift to the limit mode is sent (S104). Specifically, a selection screen is displayed on the operation section 17. If it is determined that a command for effecting a shift to the limit mode is issued (YES in S104), processing proceeds to the limit mode (S105). S105 is an example of a shift unit. During processing pertaining to S105, the phone number of the called party input through processing pertaining to S101 and a time limit, which is determined by addition of an effective period to a system time achieved at the time of shifting, are registered in the registration file 140. After the shift to the limit mode has been effected by means of processing pertaining to S105, the processing ends. In S104, if it is determined that a command to shift to the limit mode has not been issued (NO in S104), processing ends.

As mentioned above, the communication terminal device of the retransmission requested party is set as a granted device by taking communication of the retransmission request as an opportunity, thereby effecting a shift to the limit mode, whereupon information used to effect a shift to the limit mode (e.g., a phone number, a time limit, and the like) is automatically set in the registration file 140. Therefore, it is possible to save effort in performing the registration operation for operating the FAX machine in the limit mode.

The FAX machine shifts to a limit mode after ascertaining successful communication of the retransmission request, whereby the user of the requested party can be assumed to have received the retransmission request, and more accurate operation can be expected. Put another way, if the FAX machine shifts to the limit mode without performing confirmation, a shift to the limit mode may be effected despite a failure of communication of the retransmission request. In that case, it is difficult for the requested party to ascertain the fact of communication of the retransmission request, and the FAX machine will operate in the limit mode without hope of active retransmission from the requested party. Therefore, in the first exemplary embodiment, it is advantageous to check whether or not the retransmission request has been successfully completed before the FAX machine shifts to the limit mode.

[Incoming Call Processing]

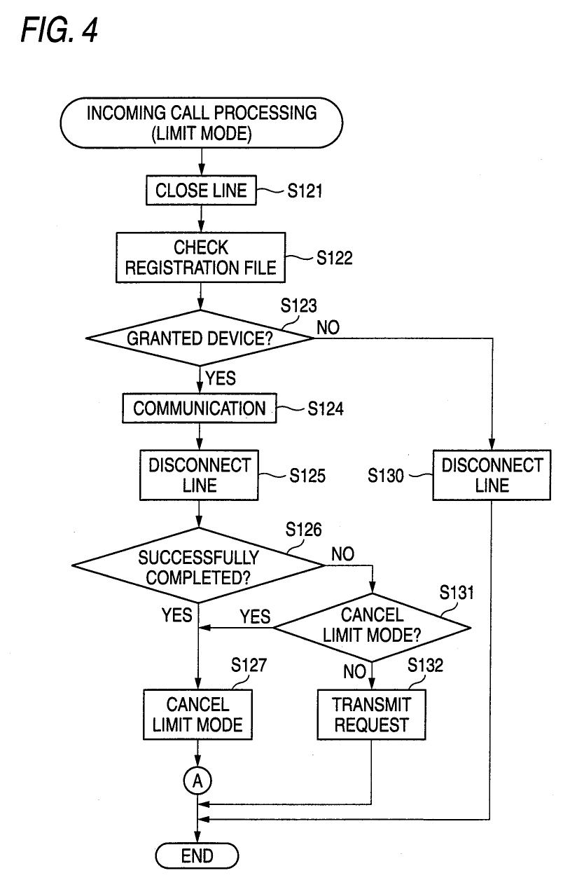

Subsequently, incoming call processing (an example of a control unit) performed when the FAX machine 100 is in the limit mode is subsequently described by reference to the flowchart shown in FIG. 4. Incoming call processing is performed every time a call number signal transmitted before closing of a line is detected.

The line is first closed (S121). Subsequently, a phone number of a calling party and a phone number of the granted device registered in the registration file 140 are checked against each other (S122). A determination is made as to whether or not the phone number of the calling party matches the phone number of the granted device; namely, whether or not the call is originated from the granted device (S123). If it is determined that the the call is not originated from the granted device (NO in S123), the circuit is disconnected (S130), and the process ends. Namely, a limitation is imposed on communication.

On the other hand, if it is determined that the call is originated from the granted device (YES in S123), communication processing is performed (S124). Specifically, communication with the FAX machine 100 is granted, and performance of a phone conversation or FAX receiving operation is performed. After completion of communication, the line is disconnected (S125).

Next, a determination is made as to whether or not communication pertaining to S124 has been successfully completed (S126). If it is determined that communication has been successfully completed (YES in S126), the limit mode is canceled (S127). Thus, communication with the communication terminal device other than the granted devices becomes feasible. During processing pertaining to S127, data recorded in the registration file 140 are initialized. Processing is ended after processing pertaining to S127.

In S126, if it is determined that communication has not been completed (NO in S126), an inquiry as to whether or not to cancel the limit mode is sent (S131). Specifically, the selection screen is displayed on the operation section 17. If it is determined that a command to cancel the limit mode is issued (YES in S131), the limit mode is canceled (S127), and processing ends. If it is determined that a command to maintain the limit mode is issued (NO in S131), the limit mode is not canceled, and the retransmission request is again transmitted (S132), whereupon processing ends.

As mentioned above, more appropriate operation can be expected by making an inquiry about cancellation of the limit mode after unsuccessful completion of communication. Specifically, when cancellation of the limit mode cannot be selected after communication has not been successfully completed, a continual wait for communication from the called party having the low chance of recovery is also conceivable, and the period of limitation may become longer. Moreover, if maintenance of the limit mode cannot be selected after unsuccessful completion of communication, even a called party having the high probability of early recovery invokes the retransmission request operation, which in turn results in an increase in user's inconvenience. Therefore, the capability to perform appropriate selection enables the user to expect performance of more appropriate operation.

[Call Origination Processing]

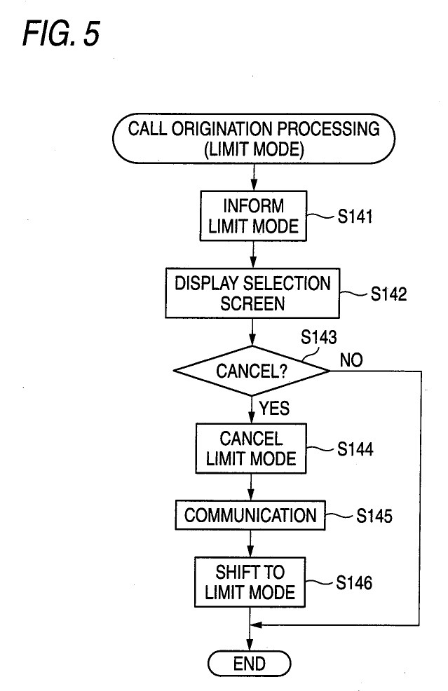

Subsequently, call origination processing performed when the FAX machine 100 is in the limit mode will be described by reference to the flowchart shown in FIG. 5. Call origination processing is performed every time a handset is operated or a FAX transmission button is pressed.

The fact that the FAX machine 100 is in the limit mode is informed (S141). S141 is an example of an informing unit. Informing operation performed by displaying a message on the display section 16 or informing operation effected by an alarm sound corresponds to informing processing. A selection screen for determining whether or not the limit mode is temporarily canceled is displayed on the display section 16 (S142). A determination is made as to whether or not performance of cancellation has been selected (S143).

If it is determined that cancellation is selected (YES in S143), the limit mode is temporarily canceled (S144). Subsequently, a call is originated to a called party, whereupon a phone conversation or FAX transmission is performed (S145). After communication, the FAX machine again shifts to the limit mode (S146), and temporal cancellation of the limit mode is completed. After processing pertaining to S146, the process ends. In S143, if it is determined that cancellation is not selected (NO in S143), processing ends.

As mentioned above, the FAX machine 100 imposes a limitation on its own call origination processing in the limit mode. Obstruction of communication from a granted device, which would otherwise be caused by a communication operation of the FAX machine itself, is prevented, so that more reliable communication with the granted device becomes possible. Further, when an attempt to originate a call is made, the FAX machine 100 informs that the machine is in the limit mode. It is therefore possible to ascertain that communication is limited, so that the user's suspicion is resolved.

[Automatic Cancellation Processing]

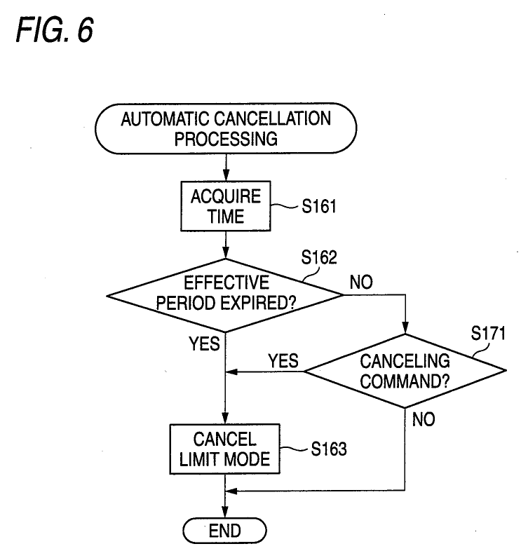

Automatic cancellation processing performed when the FAX machine 100 is in a limit mode will be subsequently described by reference to a flowchart shown in FIG. 6. Automatic cancellation processing is an example of a cancellation unit. Automatic cancellation processing is performed at intervals during the limit mode. The intervals may be predetermined. In the first exemplary embodiment, automatic cancellation processing is performed every ten seconds.

First, the current system time of the FAX machine 100 is acquired (S161). On the basis of the time and the time limit recorded in the registration file 140, a determination is made as to whether or not the effective period of the limit mode has expired (S162).

If it is determined that the effective period of the limit mode has expired (YES in S162), the limit mode is automatically canceled (S163), and processing ends. On the other hand, if it is determined that the effective period of the limit mode has not yet expired (NO in S162), a determination is made as to whether or not a command for canceling the limit mode is issued (S171). Specifically, the FAX machine 100 can cancel the limit mode at arbitrary timing by operation of the operation section 17.

If it is determined that a cancel command is issued (YES in S171), the limit mode is canceled (S163), and processing ends. If it is determined that no cancel command is issued (NO in S171), processing ends.

As mentioned above, in the FAX machine 100, an effective period is set on the limit mode. When the effective period has expired, the limit mode is forcefully canceled. An increase in the period of limitation on communication; namely, exclusive occupation of a line for a long period of time, can be avoided by automatically canceling the limit mode as mentioned above.

### Second Exemplary Embodiment

In a second exemplary embodiment, a FAX machine that sends a retransmission request to a plurality of parties will be described. In the second exemplary embodiment, a plurality of parties to be requested retransmission are sequentially set as granted devices.

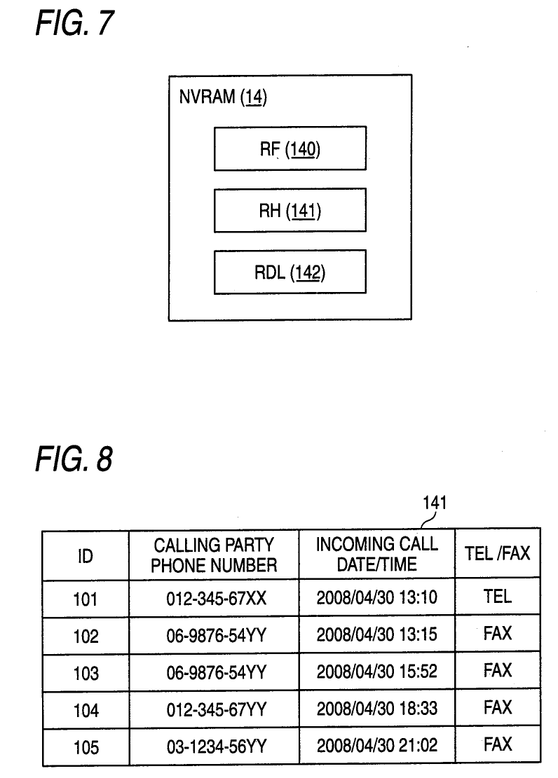

As shown in FIG. 7, the FAX machine of the second exemplary embodiment has a database for recording incoming call information about refusal of communication (hereinafter taken as a “refusal history 141”). The database is an example of a storage unit. The second exemplary embodiment also has a list of parties to be sent a request for retransmission (hereinafter taken as a “requested party list 142”), as well as the registration file 140 that records granted devices in the NVRAM 14.

FIG. 8 shows the configuration of the refusal history 141 of the second exemplary embodiment. The refusal history 141 records incoming call information about incoming calls refused during the absence mode. An ID for identifying an individual piece of incoming call information, a phone number of a calling party, the date and time of an incoming call, and the type of incoming call data are recorded as one record in the refusal history 141. Specifically, information as to whether an incoming call is a phone call or a facsimile is recorded in the type of incoming call data.

[Retransmission Request Processing]

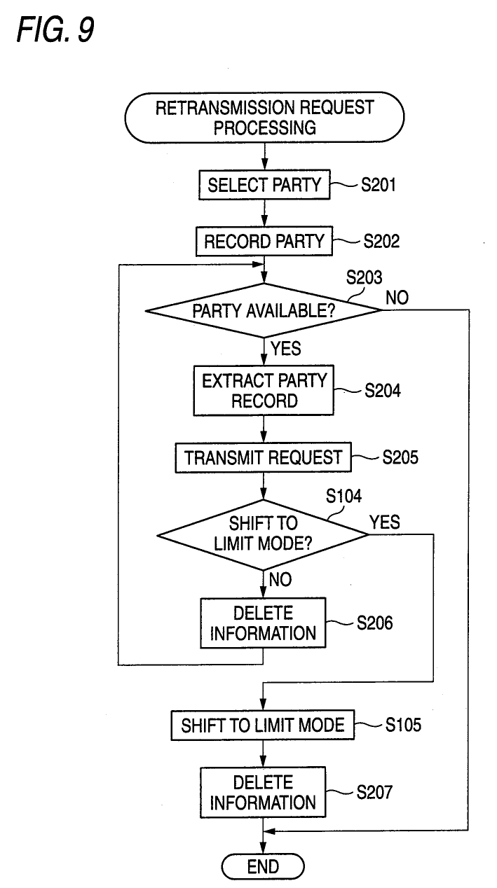

Operation of the FAX machine of the second exemplary embodiment will be subsequently described. First, retransmission request processing of the FAX machine will be described by reference to a flowchart shown in FIG. 9. As in the first exemplary embodiment, retransmission request processing is performed using the operation section 17.

A refusal list is displayed on the display section 16 on the basis of the refusal history 141, thereby allowing selection of a retransmission requested party (S201). S201 is an example of a selection unit. A phone number of the requested party is recorded in the refusal history 141, and entering a phone number during selection is not necessary. Further, a plurality of retransmission requested parties can be selected. All records of the refusal history 141 may also be displayed on the display section 161, or only incoming call information about a facsimile may also be displayed.

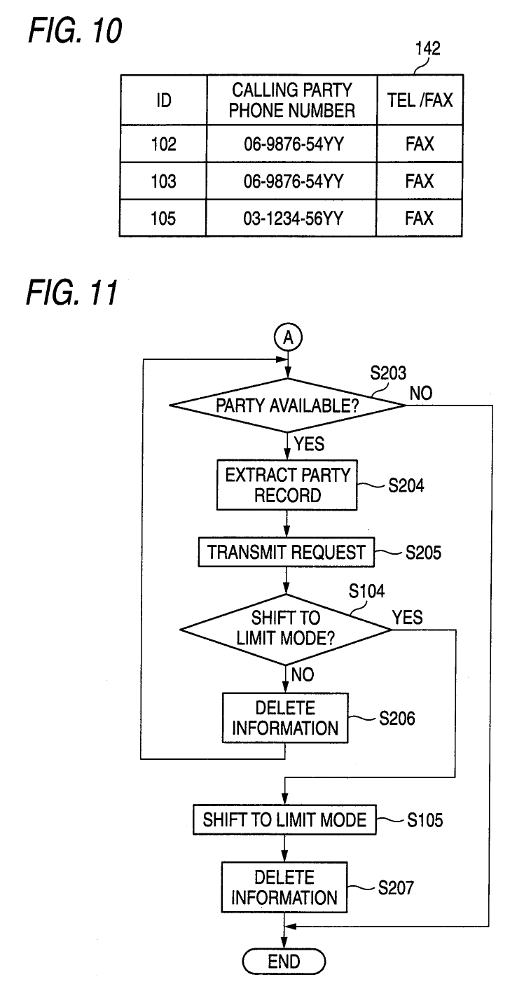

Information about the retransmission requested party selected through processing pertaining to S201 is extracted from the refusal history 141, and the information is recorded in the request list 142 (S202). In the second exemplary embodiment, as shown in FIG. 10, an ID recorded in the refusal history 141, a phone number of a called party, and the type of incoming call data are recorded as one record in the requested party list 142. The requested party list 142 records at least phone numbers of called parties, and the requested party list may also be made up solely of phone numbers of called parties. Alternatively, dates and times of incoming calls may also be recorded along with the phone numbers.

Next, a determination is made as to whether or not a retransmission requested party is available (S203). Namely, it is determined whether or not a retransmission requested party has been selected and whether or not even one record is included in the requested party list 142. If it is determined that the retransmission requested party is available (YES in S203), one record is extracted from the requested party list 142 (S204) The extraction method may also be embodied by sequential extraction of a record from the first record or random extraction of a record.

A retransmission request is then sent to the extracted retransmission requested party (S205). As in the first exemplary embodiment, the retransmission request is made by means of an audio message by phone or a request letter by FAX. The retransmission request method may also be selected for each called party or automatically selected according to the type of incoming call data.

An inquiry as to whether or not to effect a shift to the limit mode is sent (S104). If it is determined that a shift to the limit mode is selected (YES in S104), the FAX machine shifts to a limit mode in which a terminal device of a called party is taken as a granted device (S105). Processing pertaining to S104 and S105 is identical with that described in connection with the first exemplary embodiment. Moreover, information about the called party selected as a granted device is deleted from the requested party list 142 (S207), and processing ends.

On the other hand, if it is determined that a shift to the limit mode is not selected (NO in S104), the information about the party requested retransmission is deleted from the requested party list 142 (S206), and processing returns to S203. Processing is iterated until the information about the requested party is deleted from the requested party list 142 or until a granted device is set.

As mentioned above, even when a request for retransmission is informed to a plurality of called parties, only one party is admitted as a granted device at a time. Hence, communication with the granted device is not impeded. Therefore, communication with the granted device can be carried out without fail. Further, a retransmission request can be sent to another communication terminal device without entry of a phone number, so that the retransmission request operation is simple.

[Incoming Call Processing]

Subsequently, incoming call processing performed when the FAX machine of the second exemplary embodiment is in a limit mode will be described by reference to a flowchart shown in FIG. 11. The incoming call processing differs from its counterpart of the first exemplary embodiment in terms of processing subsequent to processing pertaining to S127 (processing pertaining to A in FIG. 4) in the incoming call processing of the first exemplary embodiment shown in FIG. 4. The flowchart shown in FIG. 11 describes processing pertaining to A in FIG. 4.

During incoming call processing of the second exemplary embodiment, processing (S203 in FIG. 9) in retransmission request processing of the second exemplary embodiment, which is subsequent to a determination as to whether or not there is a retransmission requested party, is performed after cancellation of the limit mode (S127 in FIG. 4). Specifically, a determination is made as to whether or not a record recording a retransmission requested party is included in the requested party list 142 (S203). If it is determined that the requested party is included (YES in S203), one record is extracted from the requested party list 142 (S203).

Next, a request retransmission is sent to the extracted retransmission requested party (S205). Next, a determination is made as to whether or not to shift to a limit mode (S104). If it is determined that a shift to the limit mode is selected (YES in S104), there is effected a shift to the limit mode by means of taking a party requested retransmission as a granted device (S105). Further, information about the requested party selected as the granted device is deleted from the requested party list 142 (S207), and processing ends.

On the other hand, if a shift to the limit mode is not selected (NO in S104), the information about the party requested retransmission is deleted from the requested party list 142 (S206), and processing returns to S203. Processing is iterated until the information about the requested party is deleted from the requested party list 142 or until a granted device is set.

As mentioned above, the next granted device is set after performance of communication with the granted device. Such incoming call processing is repeated until the records in the requested party list 142 become empty. As a result, even when a plurality of retransmission requested parties are selected, a granted device is selected one at a time, and communication with the granted device can be carried out without fail. When there is effected a shift to a grant mode for a newly-granted device, the time limit in the registration file 140 is rewritten. Therefore, a new effective period is acquired for each party. Accordingly, even when a plurality of requested parties are switched as a granted device, an appropriate effective period is set for each party.

### Third Exemplary Embodiment

In a third exemplary embodiment, a FAX machine to be inquired about a shift to a limit mode after ordinary communication will be described. In addition to having the registration file 140 that records the granted device, the FAX machine of the third exemplary embodiment has the refusal history 141 used in the second exemplary embodiment. Further, in the third exemplary embodiment, an inquiry about a shift to the limit mode is made after ordinary communication. In this regard, the third exemplary embodiment differs from the first and second exemplary embodiments in which an inquiry about a shift to the limit mode is made after issuance of a retransmission request.

[Call Origination Processing]

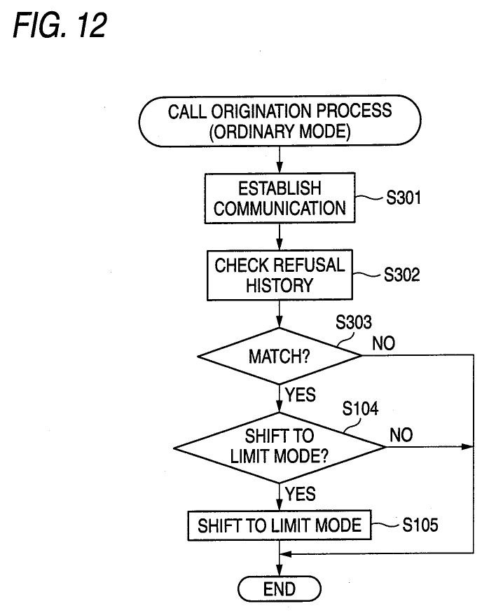

Operation of the FAX machine of the third exemplary embodiment will be described. Call origination processing of the FAX machine will be herein described by reference to a flowchart shown in FIG. 12. Call origination processing is performed in an ordinary mode every time the handset is operated or the FAX transmission button is pressed.

First, a call is originated to the communication terminal device input as a phone number of the called party, and communication is established with the called party (S301) Communication may also be ordinary phone processing or FAX transmission processing.

After completion of communication, the phone number of the called party is checked against the phone number of the calling party recorded in the refusal history 141 (S302), and a determination is made as to whether or not a match exists (S303). If it is determined that a match exists (YES in S303), an inquiry about whether or not to shift to a limit mode is made (S104). Specifically, the selection screen is displayed on the operation section 17. On the other hand, if in S303 it is determined that a match does not exist (NO in S303), processing ends.

In S104 if it is determined that a shift to the limit mode is commanded (YES in S104), there is effected a shift to the limit mode (S105). Processing pertaining to S104 and S105 is identical with that described in connection with the first exemplary embodiment. If it is determined that a shift to the limit mode is not commanded (YES in S104), processing ends.

In the third exemplary embodiment, switching to the limit mode can be automatically performed after ordinary communication. Therefore, for instance, when a retransmission request is manually issued by phone or FAX, switching to the limit mode can be continually performed after the retransmission request. Moreover, a phone number of a called party is searched through the refusal history 141, and a query about switching to a limit mode is automatically issued, thereby enabling the user to realize the called party is a refused party. Further, a shift to the limit mode in which the party is taken as a granted device can be readily effected.

As described in detail above, the FAX machine 100 of the third exemplary embodiment has the limit mode of setting in the registration file 140 a granted device for which communication is granted and of limiting communication with a communication terminal device that is not set as the granted device. The FAX machine 100 originates a call for requesting retransmission. After successful completion of communication, the communication terminal device at the retransmission requested party is set as a granted device, and there is effected a shift to the limit mode. Namely, the FAX machine 100 automatically sets information (e.g., a phone number, a time limit, and the like) used to effect a shift to the limit mode in the registration file 140, taking origination of a call to the retransmission requested party as an opportunity. Therefore, it is possible to save efforts pertaining to registration operation for operating the FAX machine in the limit mode, and operation becomes more simple. Therefore, convenience is enhanced.

The above-described exemplary embodiments are mere illustrations and do not pose any limitation on the present inventive concept. Therefore, the present inventive concept is naturally susceptible to various improvements and alterations within the scope of the claims. For instance, in the exemplary embodiments, the present inventive concept is applied to a FAX-specific machine, but the present inventive concept is not limited to the machine. Specifically, the present inventive concept can also be applied to any communication device, so long as the device has a communication function. For example, the present inventive concept may alternatively be applied to a multifunction machine (MFP) having a phone function and a FAX function or a personal computer (PC) having a phone function and a FAX function. Alternatively, the present inventive concept can also be applied to a simple phone or a portable cellular phone.

The FAX machine of the exemplary embodiments cancel the limit mode by means of an effective period or communication from a granted device. However, a trigger for cancellation is not limited, and cancellation may also be performed in accordance with a cancel command from the granted device.

According to an illustrative aspect of the present invention, a communication device is provided that includes a call origination unit that originates a call to a designated communication terminal device; a shift unit that sets as a granted device the communication terminal device to which the call has been originated, taking call origination performed by the call origination unit as an opportunity, and that effects a shift to a limit mode in which communication with a communication terminal device not set as the granted device is limited; and a control unit that determines whether or not an incoming call is from the granted device when an incoming call is received during the limit mode, that permits communication when the incoming call is from the granted device, and that limits communication when the incoming call is from a device other than the granted device.

The communication device includes a limit mode (a line use limit function) in which a granted device to be granted communication is set and in which a limitation is imposed on communication with a communication terminal device not set as the granted device. The communication terminal device of the called party may be set as a granted device while origination of a call to a designated communication terminal device is taken as an opportunity. Designation of a communication terminal device may also be performed by entry of a phone number or selection of a party from a list of parties displayed on a display screen. Subsequently, the communication device determines whether or not an incoming call is from the granted device when an incoming call is received during the limit mode, and that limits communication when the incoming call is from a device other than the granted device.

Specifically, after origination of a call to the communication terminal device, the communication device shifts to a limit mode in which a communication terminal device of the called party is taken as a granted device. Therefore, efforts to perform registration operation for causing the communication device to operate in the limit mode, such as entry of a phone number, can be saved, and operation is made more simple. Therefore, convenience is enhanced.

It is advantageous that the limit mode be effective during a given period of time since initiation of operation of the communication device. Specifically, since the limit mode ends in a specified period of time, long-period occupation of a line can be avoided.

It is advantageous that the communication device have; for instance, an effective period for the limit mode; and that the communication device further have a cancellation unit that terminates the period of time, to thus cancel the limit mode, when the limit mode has passed the effective period. Cancellation of the limit mode, which would otherwise be performed by a receiving end, can be managed by setting an effective period. Moreover, it is advantageous that the control unit cancels the limit mode by terminating the period of time, taking communication from the granted device as an opportunity. The communication device can be efficiently utilized by canceling the limit mode while taking resolution of reasons for limitation as an opportunity.

It is advantageous that the control unit limit, during the limit mode, call originating operation performed by the call origination means. Specifically, the communication device can establish communication with a granted device more reliably by limiting a call originating operation of the communication device.

It is advantageous that the communication device further have an informing unit for informing that the device is in the limit mode. Specifically, it can be conceived that imposing a limitation on communication may not be easily recognizable. Accordingly, it can be expected to make recognition of the limit mode more easy by indicating the limit mode.

It is advantageous that the communication device further have a selection unit for selecting at least one called party; that the call origination unit sequentially originates a call to communication terminal devices of called parties selected by the selection unit; and that the limit mode be sequentially set for the respective communication terminal devices. Specifically, in the communication device, a plurality of parties are made selectable as called parties, and the communication device is sequentially switched to the limit mode with regard to the plurality of parties. In short, the parties are sequentially set as a granted device. In the communication device, even when a call is originated to a plurality of parties, a granted device is one. Therefore, communication can be reliably established with the communication terminal device set as a granted device.

It is advantageous that the shift unit effects a shift to the limit mode, taking successful completion of communication with the communication terminal device of the called party as an opportunity. Specifically, when the communication device immediately shifts to the limit mode after originating a call, the device enters the limit mode even if receipt of the call is rejected by the party, and the limit mode is effected in a situation where it is difficult to expect the party to establish active communication. Accordingly, timing to effect a shift to the limit mode is set by not only a call origination but also after successful completion of communication with the called party. As a result, more accurate operation can be obtained.

It is advantageous that the communication device further have a facsimile communication function; and storage unit that stores incoming call information about unsuccessful printing of facsimile data, and that the call origination unit originate a call in accordance with the incoming call information stored in the storage unit.

According to the present invention, a communication device capable of setting parties for which communication is granted is implemented without performance of complicated operations.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. A communication device comprising:
a call origination unit that originates a call to a communication terminal device;
a shift unit that sets as a granted device the communication terminal device to which the call has been originated, and that shifts the communication device to a limit mode in which communication with a communication terminal device which is not set as a granted device is limited, after the call is originated by the call origination unit; and
a control unit that determines whether an incoming call is from a granted device when an incoming call is received while the communication device is in the limit mode, that permits communication if the incoming call is from a granted device, and that limits communication if the incoming call is from a device other than a granted device.

2. The communication device according to claim 1, wherein the communication device operates in the limit mode for a set period of time after an initiation of the communication device.

3. The communication device according to claim 2, wherein an effective period is set for the limit mode; and the communication device further comprises a cancellation unit that terminates the set period of time, to thus cancel the limit mode, when the communication device has operated in the limit mode for the effective period.

4. The communication device according to claim 2, wherein the control unit cancels the limit mode by terminating the set period of time at a time at which the incoming call from the granted device is taken.

5. The communication device according to claim 1, wherein, while the communication device is in the limit mode, the control unit limits a call originating operation performed by the call origination unit.

6. The communication device according to claim 1, further comprising
an informing unit that indicates that the communication device is in the limit mode.

7. The communication device according to claim 1, further comprising:
a selection unit which selects at least one called party, wherein
the call origination unit sequentially originates a call to communication terminal devices of called parties selected by the selection unit; and
the limit mode is sequentially set for the respective communication terminal devices.

8. The communication device according to claim 1, wherein the shift unit effects a shift to the limit mode after successful completion of a communication with a communication terminal device of a called party.

9. The communication device according to claim 1, further comprising:
a facsimile communication unit; and
a storage unit that stores incoming call information about unsuccessful printing of facsimile data, wherein
the call origination unit originates a call in accordance with the incoming call information stored in the storage unit.
